(19) United States
(12) Patent Application Publication
(10) Pub. No.: US 2026/0369569 A1
(43) Pub. Date: Nov. 19, 2026

(54) SUPPORT FOR A LITHIUM METAL NEGATIVE ELECTRODE AND A METHOD FOR MANUFACTURING THE SAME

(71) Applicants: HYUNDAI MOTOR COMPANY, Seoul (KR); KIA CORPORATION, Seoul (KR); GWANGJU INSTITUTE OF SCIENCE AND TECHNOLOGY, Gwangju (KR)

(72) Inventors: Seungjong Lee, Hwaseong-si (KR); Jongchan Song, Hwaseong-si (KR); Areum Ha, Hwaseong-si (KR); Seongmin Ha, Hwaseong-si (KR); Seongju Hwang, Hwaseong-si (KR); Yunseo Jeoun, Hwaseong-si (KR); Sangheon Lee, Hwaseong-si (KR); Seoyoung Choi, Hwaseong-si (KR); Kwang Sup Eom, Gwangju (KR); Jinhyeon Jo, Gwangju (KR)

(73) Assignees: HYUNDAI MOTOR COMPANY, Seoul (KR); KIA CORPORATION, Seoul (KR); GWANGJU INSTITUTE OF SCIENCE AND TECHNOLOGY, Gwangju (KR)

(21) Appl. No.: 19/529,025

(22) Filed: Feb. 3, 2026

(30) Foreign Application Priority Data
May 14, 2025 (KR) 10-2025-0062293

(51) Int. Cl. H01M 4/36; H01M 4/02; H01M 4/04; H01M 4/38; H01M 4/62

(52) U.S. Cl. CPC H01M 4/366; H01M 4/04; H01M 4/382; H01M 4/625; H01M 4/626; H01M 2004/021; H01M 2004/027

(57) ABSTRACT

A support for the lithium metal negative electrode includes: a separator; a layer including conductive metal nanoparticles on the separator; and a lithium affinity layer on the layer including conductive metal nanoparticles, wherein the layer including conductive metal nanoparticles further includes pores therein.

### CROSS-REFERENCE TO RELATED APPLICATION

This application claims priority to and the benefit of Korean Patent Application No. 10-2025-0062293 filed with the Korean Intellectual Property Office on May 14, 2025, the entire contents of which are incorporated herein by reference.

### FIELD

The present disclosure relates to a support for a lithium metal negative electrode and a method of manufacturing the same.

### BACKGROUND

Climate changes caused by environmental pollution and global warming are causing environmental disasters and threatening life. Accordingly, alternatives to internal combustion engines that can carry out environment-friendly energy storage/transfer processes are being researched. Among them, rechargeable lithium batteries, which do not discharge carbon during the storage/transfer processes and have high energy density and output density, are attracting attention as a power source for not only small electronic devices but also environment-friendly electric vehicles.

As a next generation negative electrode material for the rechargeable lithium batteries, lithium metal, which has high theoretical capacity (3862 mA h g-1, 2046 mA h cm-3) and a low standard redox potential (−3.03 V_{SHE (standard hydrogen electrode)}), may replace a conventional graphite negative electrode and significantly increase energy density and output density of the batteries. However, there are safety and stability issues such as reduced cycle-life performance due to lithium deposition in the form of dendrites, fire and explosion due to cell short-circuit, and the like during the charging/discharging process.

Accordingly, a method of suppressing the dendrite formation by using a constructive porous structure with a large electrochemically active surface area to reduce effective current density has been proposed. However, in the actual lithium electrodeposition process, the lithium is electrodeposited not inside the structure due to diffusion resistance of lithium ions but on the outside of the structure where the diffusion resistance of lithium ions is smaller. To improve this phenomenon, a method of coating a lithium affinity material onto a structure such as a copper (Cu) foam or carbon paper has been developed. In this case, the lithium may be induced to be internally electrodeposited, but this method has problems of being not suitable for large area electrodes and significantly reducing capacity per weight/volume due to a high thickness and weight and thereby, being unsuitable for manufacturing batteries with commercially required energy density and output density.

### SUMMARY

To maintain high capacity per weight/volume, a porous structure having a thinner thickness but high porosity and a low weight should be manufactured. In addition, it should be implemented in an easy way suitable for manufacturing large-area electrodes. In an embodiment, a support for a lithium metal negative electrode and a method for manufacturing the same are provided.

The technical problem to be solved by one or more embodiments of the present disclosure is to form a lithium affinity gradient by introducing lithium affinity silver (conductive metal element) to the lower end of a layer including conductive metal nanoparticles such as a copper structure, thereby inducing lithium to be electrodeposited from the lower end of the structure, thereby suppressing lithium dendrite growth and alleviating volume expansion during the charge/discharge process, thereby increasing the stability of the battery.

A support for a lithium metal negative electrode having the lithium affinity gradient according to an embodiment may include: a separator; a layer including conductive metal nanoparticles and being on the separator; and a lithium affinity layer on the layer including conductive metal nanoparticles, wherein the layer including conductive metal nanoparticles further includes pores therein.

A method for manufacturing a support for a lithium metal negative electrode having the lithium affinity gradient according to another embodiment may include: adding a mixture of a conductive metal element, a conductive carbon fiber, and a binder to a solvent; adding a pore-forming agent to the solvent to which the mixture is added to prepare a slurry; casting the slurry onto a separator; drying the slurry casted onto the separator; etching after the drying to obtain a support for a lithium metal negative electrode in a first state (e.g., a state in which the support does not have a lithium affinity gradient); and reacting the support in the first state with a solution including a lithium ion affinity element.

The present disclosure relates to a high-performance lithium metal negative electrode support having a lithium affinity gradient and a method for manufacturing the same. According to an embodiment, the support for the lithium metal negative electrode may be a copper (conductive metal element) structure having a lithium affinity gradient, and when plating, lithium plating may occur from the lower end of the structure, thereby alleviating volume expansion during charging/discharging and simultaneously improving the cycle-life and capacity of a battery.

Specifically, the lithium metal support according to an embodiment of the present disclosure may have a structure in which a lithium affinity gradient is formed by easily introducing a lithium affinity material, such as silver, into the structure through a galvanic substitution reaction according to a difference in reduction potential, and a float coating technique not reported in other patents or papers may be applied. This method may utilize the hydrophobic properties of the separator and amorphous carbon to modify only the surface of the carbon layer with a conductive metal element such as silver (Ag), and this part may become the lower portion of the lithium metal negative electrode when manufacturing the cell. Therefore, unlike lithium being electrodeposited on the surface of a conventional conductive porous structure, lithium-affinity silver may react with lithium first, enabling lithium electrodeposition from the lower portion. In addition, the technique has the advantage of enabling large-area coating of conductive metal elements such as Ag in a short period of time. By using the above structure in a lithium metal negative electrode, internal electrodeposition of lithium may be enabled, thereby suppressing lithium dendrite growth during the charge/discharge process and alleviating volume expansion of lithium metal.

### BRIEF DESCRIPTION OF THE DRAWINGS

FIG. 1 is a schematic view showing a method for manufacturing a support according to Comparative Example 2 and Example 1 where the upper part of FIG. 1 (up to the step of removing NaCl by etching the etching material in water) is a schematic view of a method for manufacturing a support for a lithium metal negative electrode without a lithium affinity gradient, and the lower part of FIG. 1 (up to the step of performing a galvanic substitution reaction after the etching) is a schematic view of a method for manufacturing a support for a lithium metal negative electrode with a lithium affinity gradient.

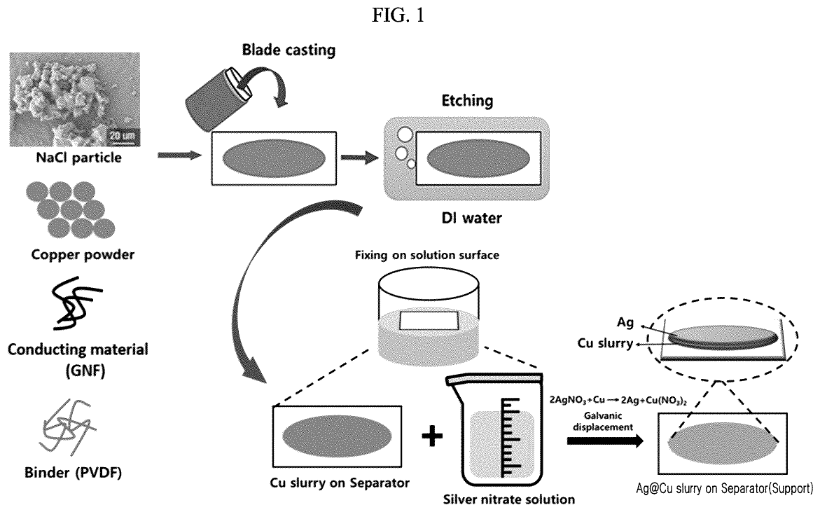

FIG. 2 is a photograph of a support for a lithium metal negative electrode without a lithium affinity gradient according to Comparative Example 2.

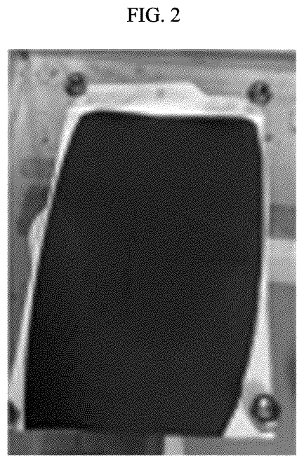

FIG. 3 is a photograph of a support for a lithium metal negative electrode having a lithium affinity gradient according to Example 1.

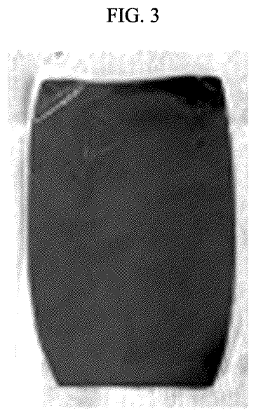

FIG. 4 is a graph showing the substitution ratio of copper (Cu) to silver (Ag) as the silver nitrate coating time increases, according to one embodiment.

FIG. 5 is a half-cell data for confirming the optimization of Ag content, according to one embodiment.

FIG. 6 shows cross-sectional scanning electron microscopy (SEM) images and Energy-Dispersive X-ray Spectroscopy (EDS) analysis data according to silver nitrate coating time, according to one embodiment.

FIG. 7 shows data using a two-terminal direct current (DC) resistance measurement method according to the ratio of conductive material (graphite nanofiber (GNF)), according to one embodiment.

FIG. 8 shows the electrochemical evaluation data of a half-cell according to the ratio of the conductive material (GNF), according to one embodiment.

FIG. 9 shows scanning electron microscope (SEM) cross-sectional photographs of a support after lithium electrodeposition according to Comparative Example 1.

FIG. 10 shows scanning electron microscope (SEM) cross-sectional photographs of a support after lithium electrodeposition according to Comparative Example 2.

FIG. 11 shows scanning electron microscope (SEM) cross-sectional photograph of a support after lithium electrodeposition according to Example 1.

FIG. 12 shows graphs showing the difference in nucleation overvoltage during lithium electrodeposition of the support according to Comparative Example 1, Comparative Example 2, and Example 1.

FIG. 13 shows the cycle-life evaluation data of half-cells including supports according to Comparative Example 1, Comparative Example 2, and Example 1.

FIGS. 14A and 14B show the symmetrical cell cycle-life and output evaluation data including the support according to Comparative Example 1, Comparative Example 2, and Example 1.

FIGS. 15A and 15B are a full cell cycle-life and output evaluation data including a support according to Comparative Example 1, Comparative Example 2, and Example 1.

### DETAILED DESCRIPTION

Special terms used herein is for the purpose of describing embodiments only and are not intended to be limiting of the present disclosure. Singular forms used herein shall be deemed to include the plural as well, unless the wording clearly expresses a contrary intention. The term “including” or “comprising” used in the specification means that a specific feature, region, integer, step, operation, element and/or component is embodied and other specific features, regions, integers, steps, operations, elements, and/or components are not excluded.

Unless defined otherwise, all terms including technical and scientific terms used herein have the same meaning as commonly understood by those having ordinary skill in the art to which the present disclosure belongs. Commonly used predefined terms are further interpreted as having a meaning consistent with the relevant technical literature and the present disclosure, and are not to be construed as ideal or very formal meanings unless defined otherwise.

Terms including first, second, and third are used for describing various arts, components, regions, layers, and/or sections, but are not limited thereto. The terms are only used to distinguish any part, component, region, layer, or section from the other part, component, region, layer, or section. Accordingly, the first part, component, region, layer, or section described below may be mentioned as the second part, component, region, layer, or section within the range without departing from the range of the present disclosure.

Also, unless specifically stated otherwise, % means wt %, and if no unit is specified separately, the unit based on weight is omitted.

As used herein, the term “combination(s) thereof” described in the expression in the Markush format refers to one or more mixtures or combinations selected from the components described in the expression in the Markush format, and refers to including at least one selected from the components. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Hereinafter, embodiments are described in detail. However, these embodiments are examples, and this disclosure is not limited thereto.

### Support for Lithium Metal Negative Electrode

Recently, as concerns about fossil fuel shortages and environmental pollution have been growing, there is a growing demand for environment-friendly energy storage/conversion devices. Among them, rechargeable lithium batteries are used as a core component in environment-friendly electric vehicles as well as small electronic devices due to high electric power density, energy density, long cycle-life, and environmental friendliness and thus have potentials capable of replacing conventional internal combustion engines.

A lithium metal, which has high capacity (3862 mAh·g-1, 2046 mAh·cm-3) and low reduction potential, is regarded as a negative electrode material for next generation rechargeable lithium batteries and may produce high energy and electric power. However, there are problems such as cell short-circuits, dead lithium formation, volume expansion, and the like due to lithium dendrites generated during the charging/discharging process.

To solve these problems, a solution of using a conductive porous structure with a high electrochemically active surface area to reduce local current density and thus suppress the dendrite formation has been proposed. However, when the conductive porous structure is used, because most of the lithium is electrodeposited on the surface of the structure where a lithium ion diffusion distance is short, the dendrite formation is not suppressed. As a method of improving such a lithium metal negative electrode support, a porous structure with a lithium affinity gradient needs to be manufactured, but a conventional support with a lithium affinity gradient, wherein the lithium affinity gradient is formed by stacking multiple layers containing and not containing a lithium affinity material after introducing the lithium affinity material into the structure, has a problem of complicated and cost-ineffective process. In addition, the conventional porous structure in the form of a foam is very thick, which causes a problem of reducing energy density and thereby making it difficult to use it commercially. Accordingly, to solve this problem, an embodiment of the present disclosure provides a structure having an appropriate thickness that allows lithium to be electrodeposited from the inside by introducing the lithium affinity gradient into the structure rather than forming the several layers.

An embodiment of the present disclosure has achieved a technical task of easily introducing the lithium affinity gradient into the porous structure through a galvanic substituted reaction according to a reduction potential difference without stacking multiple layers, ensuring the structure to have an appropriate thickness through a slurry casting method to induce internal electrodeposition of lithium and thus alleviate volume expansion during the repeated charge/discharge processes, and thereby, securing battery stability and improving performance.

Conventional domestic and international research on the lithium metal negative electrode support has been directed toward manufacturing a conductive porous structure. The conductive porous structure has been designed to allow lithium to be electrodeposited into its pores and thus alleviate the volume expansion during the charge/discharge processes. In addition, the structure has a large electrochemically active surface area, which reduces local current density, thereby inhibiting the dendrite growth.

However, in the conventional conductive porous structure studied to date, most of the lithium is electrodeposited on the surface of the structure due to a short diffusion distance of lithium ions. This makes the pores of the structure unusable during the charge/discharge process, resultantly generating the volume expansion and increasing cell short-circuiting risks. Therefore, the need for a new structure capable of internally electrodepositing lithium is growing.

The lithium metal support according to an embodiment of the present disclosure has a conductive porous structure but clearly differentiated form the conventional conductive porous structure, in that the lithium is electrodeposited not on the surface but from the inside of the structure and that the structure is not so thick as to minimize or reduce energy density loss of a battery employing the same.

The support for the lithium metal negative electrode having the lithium affinity gradient according to an embodiment includes: a separator; a layer including conductive metal nanoparticles and being on the separator; and a lithium affinity layer on the layer including conductive metal nanoparticles. The layer including conductive metal nanoparticles further includes pores therein.

For example, since the substrate used as the separator functions as a simple coating substrate, there is no particular limitation as long as it is used as a separator of a general rechargeable lithium battery, and for example, a porous polymer film such as polyethylene (PE) or polypropylene (PP), a non-woven film composed of directional or random fibers, an inorganic composite film manufactured by complexing inorganic nanoparticles with a polymer, a ceramic separator manufactured from a ceramic material such as aluminum oxide (Al₂O₃) or lithium aluminum titanium phosphate (LATP), a glass fiber separator formed by squeezing thin glass fibers to form a porous structure, a non-woven separator formed by entangling synthetic fibers to form a porous structure, a PP/PE/PP three-layer composite film, a fluorine-coated separator, and the like can be used.

For example, the support for the lithium metal negative electrode having the lithium affinity gradient may have a porosity in a range of 60% to 97%, for example, 60% to 95%, for example, 70% to 95%, for example, 70% to 90%, for example, or, for example, 75% to 85%. The support for a lithium metal negative electrode according to an embodiment has a very high porosity in the above range, so that a lithium affinity gradient suitable for a large-area electrode may be easily achieved, and the phenomenon of lithium being electrodeposited on the upper portion of the support may be prevented, and internal electrodeposition of lithium may be induced. The pores may be formed using a pore forming agent. As the pore forming agent, sodium chloride (NaCl), sucrose, or a combination thereof, which are harmless to the human body, may be used. In addition, silica, polymethyl methacrylate (PMMA), styrene, iron oxide (Fe₂O₃), nickel (II) oxide (NiO), alumina (Al₂O₃), or a combination thereof may also be used. The porosity of the support for the lithium metal negative electrode having the lithium affinity gradient may be controlled by a volume ratio of the conductive metal nanoparticles and the etchable pore forming agent, and the pore diameter of the support for the lithium metal negative electrode having the lithium affinity gradient may be controlled by the size of the pore forming agent such as NaCl. In other words, according to an embodiment, the porosity and pore size may be easily controlled, so that it is possible to manufacture lithium metal batteries having various specifications.

For example, the lithium affinity layer may further include a lithium ion affinity element.

In other words, the lithium affinity gradient according to an embodiment may be implemented with the lithium affinity layer, and the lithium affinity gradient may be one in which the lithium concentration gradually decreases in the direction of the lithium affinity layer, the layer including conductive metal nanoparticles, and the separator. In an embodiment, since a portion of the conductive nanoparticles is provided with lithium affinity by electroless plating after coating conductive nanoparticles (the portion where electroless plating occurs plays a lithium affinity role), a coating layer is floated on a solution where electroless plating occurs and only a portion is reacted, so that the lithium affinity gradient is formed by electroless plating, and the proportion of the affinity layer may gradually decrease from the lithium negative electrode layer toward the separator.

The lithium ion affinity element is an element that shows a strong affinity for lithium ions, and may include both a metal/non-metal element that forms an alloy with lithium and an element that contains a functional group that has a strong affinity for lithium ions, and may include, for example, silver (Ag), zinc (Zn), gold (Au), aluminum (AI), carbon (C), or a combination thereof.

For example, the layer including conductive metal nanoparticles may include a conductive metal element and conductive carbon fiber. The conductive metal element may include copper (Cu), iron (Fe), nickel (Ni), or a combination thereof, and the conductive carbon fiber may include a carbon nanotube (CNT), a graphite nanofiber (GNF), or a combination thereof.

The support for the lithium metal negative electrode having the lithium affinity gradient may further include a binder.

The binder serves to improve the adhesion between the conductive carbon fiber and the pore forming agent and the adhesive strength to the separator. Examples may include polyvinylidene fluoride (PVDF), vinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene monomer rubber (EPDM rubber), sulfonated-EPDM, styrene butadiene rubber (SBR), fluoroelastomer, or various copolymers thereof, and may be used alone or a mixture of two or more thereof. More specifically, in one example it may be polyvinylidene fluoride (PVDF).

The conductive carbon fiber may be included in an amount in a range of 1 wt % to 5 wt %, for example, more than 1 wt % and less than 5 wt %, for example, 2 wt % to 4 wt %, for example, 3 wt %, based on the total weight (100 wt %) of the conductive metal element, the conductive carbon fiber, and the binder. When the conductive carbon fiber is included in an amount of less than 1 wt % based on the total weight of the support for the lithium metal negative electrode having the lithium affinity gradient, the amount of the conductive carbon fiber is too small to lower the electrical conductivity, and the decrease is so high that electrical connection between the structures is not made, and thus the structure cannot function. When the conductive carbon fiber is included in an amount of more than 5 wt % based on the total weight of the support for the lithium metal negative electrode, the electrical conductivity is so high that lithium may be electrodeposited on the structure. In one example, the conductive carbon fiber may be a graphite nanofiber (GNF) rather than a carbon nanotube (CNT).

For example, the support for the lithium metal negative electrode having the lithium affinity gradient may have a thickness in a range of 10 μm to 100 μm, for example, 20 μm to 80 μm, for example, 20 μm to 60 μm, for example, 20 μm to 50 μm, and for example, may have a thickness of 35 μm. The thickness of the support for the lithium metal negative electrode may be easily controlled by adjusting the casting thickness described below. In other words, since the support for the lithium metal negative electrode having a lithium affinity gradient according to an embodiment may be controlled through the production of an electrode using a casting method, it is possible to manufacture a lithium metal battery having various specifications using the support.

### Method for Manufacturing Carbon Fiber Support for Lithium Metal Negative Electrode

A method for manufacturing a support for a lithium metal negative electrode having the lithium affinity gradient according to an embodiment includes: adding a mixture of a conductive metal element, a conductive carbon fiber, and a binder to a solvent; adding a pore-forming agent to a solvent to which the mixture is added to prepare a slurry; casting the slurry onto a separator; drying the slurry casted onto the separator; etching, after drying the slurry casted onto the separator, to obtain a support for a lithium metal negative electrode in a first state (e.g., a state in which the support does not have a lithium affinity gradient); and reacting a support for a lithium metal negative electrode in the first state with a solution including a lithium ion affinity element.

The porous structure (lithium metal support) of an embodiment may be prepared by: mixing conductive carbon fibers, conductive metal elements, and a binder, which constitute the structure, in a specific mass ratio and adding the mixture to a solvent: adding an etching material (a pore forming agent) that can be etched with deionized (D.I.) water thereto, and ball-milling them to prepare a slurry; casting the slurry on a separator with a doctor blade; drying it; and etching it with the D.I. water to manufacture a support for a lithium metal negative electrode having high porosity. However, the support for a lithium metal negative electrode obtained in this step has no lithium affinity gradient yet. Subsequently, the lithium metal negative electrode support having no lithium affinity gradient yet is reacted with a solution including lithium ion affinity elements to implement the lithium affinity gradient and to obtain the support in a second state in which the support for the lithium metal negative electrode includes the lithium affinity gradient. Through this lithium affinity gradient, internal electrodeposition of lithium may be easily induced and made suitable for large-area applications.

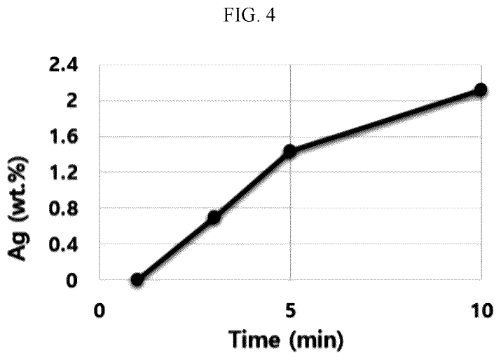

The lithium affinity treatment method is introduced by float-coating the lithium metal negative electrode support having no lithium affinity gradient in the solution including lithium ion affinity elements. When the float coating method is applied, the lithium ion affinity elements may be very easily formed only on the surface of the structure. Specifically, the lithium metal negative electrode support having no lithium affinity gradient may be floated in a silver nitrate (AgNO₃) aqueous solution for a predetermined time, manufacturing a conductive porous structure having the lithium affinity gradient rich in silver on the surface through a galvanic substitution reaction (refer to FIG. 4). The silver nitrate (AgNO₃) aqueous solution may be adjusted to a specific concentration to control an Ag content. To the porous structure, a pore forming agent may added to alleviate aggregation of the conductive carbon fibers. The weight of the porous structure may be reduced to 0.12 mg/cm² or less per 10 μm, enabling the implementation of a battery with high energy per weight/volume.

For example, the pore forming agent may include NaCl, sucrose, silica, PMMA, styrene, iron oxide (Fe₂O₃), nickel (II) oxide (NiO), alumina (Al₂O₃), or a combination thereof. In particular, in one example, the NaCl and/or sucrose may be etched with water alone, and thus the processability may be greatly improved when manufacturing the porous structure (lithium metal support) according to an embodiment of the present disclosure.

According to an embodiment, the porous structure (of the support for lithium metal negative electrode) having the lithium affinity gradient may easily control the microscopic structure through the use of micrometer-sized particles and etching and casting methods, and may also easily control the macroscopic structure through the production of the electrode using the casting method. In other words, the method for manufacturing a support for a lithium metal negative electrode having a lithium affinity gradient according to an embodiment may easily control the microscopic structure and the macroscopic structure simultaneously or selectively, thereby enabling the manufacture of lithium metal batteries having various specifications.

The step of reacting the lithium metal negative electrode support having no lithium affinity gradient with the solution including lithium ion affinity elements may be performed for greater than 1 minute and less than 10 minutes, for example, 1 minute to 10 minutes, for example, 1 minute to 5 minutes, for example, 2 minutes to 4 minutes, or for example, 3 minutes. This is to substitute with the lithium ion affinity elements (e.g., Ag) for conductive metal elements (e.g., Cu) in an electroless plating method, wherein if the lithium metal negative electrode support having no lithium affinity gradient is reacted with the solution including the lithium ion affinity elements within the time ranges, as the lithium ion affinity elements may be substituted at a higher ratio, the lithium ion affinity elements such as Ag may have a higher ratio, while simultaneously maintaining excellent cell performance. If the reaction time is less than 1 minute, which is too short, there is almost no amount of the lithium ion affinity elements, but if the reaction time is greater than 10 minutes, the cell performance may be deteriorated.

In the method of manufacturing the lithium metal negative electrode support having the lithium affinity gradient according to an embodiment, the conductive carbon fibers, the pore forming agent, the binder, and the like are as described above, and in addition, the other components also may be as described above.

As described above, a lithium metal battery according to an embodiment of the present disclosure may have an excellent cycle-life and, in addition, excellent electrochemical properties, and therefore may be useful in portable devices such as mobile phones, laptop computers, and digital cameras, and electric vehicles such as hybrid electric vehicles (HEVs).

The following examples illustrate one or more embodiments of the present disclosure in more detail. However, the following examples are only embodiments of the present disclosure, and the present disclosure is not limited to the following examples.

### Comparative Example 1: Copper Foil

As a control group, a copper foil (Cu foil) was used.

### Comparative Example 2: Manufacturing of a Conductive Porous Structure without a Lithium Affinity Gradient

Copper particles, a conductive material, and a binder (PVDF) in a mass ratio of 87:3:10 were added to an NMP (N-Methyl-2-pyrrolidone) solvent, and an etching material of NaCl was added thereto to achieve porosity of 80%. The mixture was ball-milled and then, cast on a separator by using a doctor blade. After drying, the etching material was etched with water to remove NaCl, obtaining a conductive porous structure.

### Example 1: Manufacturing of a Conductive Porous Structure Having a Lithium Affinity Gradient

Copper particles, a conductive material, and a binder (PVDF) in a mass ratio of 87:3:10 were added to an NMP (N-Methyl-2-pyrrolidone) solvent, and an etching material of NaCl was added thereto to achieve porosity of 80%. The mixture was ball-milled and then, cast on a separator by using a doctor blade. After drying, the etching material was etched with water to remove NaCl, obtaining the conductive porous structure of Comparative Example 2. This structure was floated in a silver nitrate aqueous solution for 3 minutes, obtaining a conductive porous structure with a lithium affinity gradient rich in silver on the surface through a galvanic substituted reaction.

Conditions applied to the following evaluation
Lithium with a thickness of 170 μm was layered on a conductive porous structure and then, used as a counter electrode and a reference electrode, and the conductive porous structure was used as a working electrode to test electrochemical performance at various current densities and electrodeposition times.
In the electrochemical analysis, used was an electrolyte prepared by dissolving Lithium bis(trifluoromethanesulfonyl)imide LiTFSI salt at a concentration of 1 M in a solvent including DOL (1,3-dioxolane)/DME (1,2-dimethoxyethane) in a volume ratio of 1:1 and 1% (weight %) of LiNO₃. (Symmetric cell test, full cell test)
In this electrochemical analysis, used was an electrolyte prepared by dissolving LiTFSI salt at a concentration of 1 M in a solvent including DOL (1,3-dioxolane)/DME (1,2-dimethoxyethane) in a volume ratio of 1:1 and 2% (weight %) of LiNO₃. (Half-cell test)

### Evaluation 1: Control of Silver Nitrate Solution Reaction Time of the Structure

In an electroless plating method of substituting Cu with Ag (Cu→Ag), as a structure is longer reacted in a silver nitrate solution, Ag has a higher ratio.

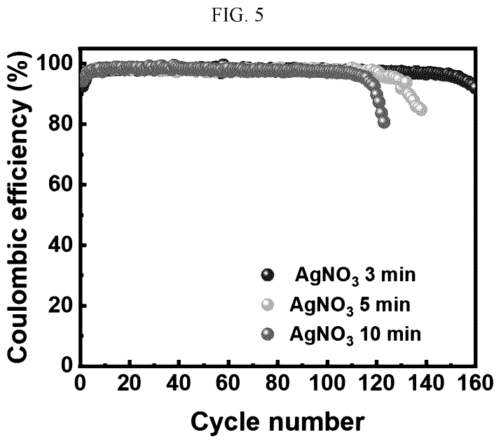

Each Ag and Cu ratio was checked at each reaction time of 1 minute, 3 minutes, 5 minutes, and 10 minutes, and the results are shown in Table 1 and FIG. 4. The coin half-cell test exhibited the highest performance was achieved at the reaction time of 3 minutes (refer to FIG. 5).

The 1 minute reaction, which was the shortest reaction time, exhibited an Ag amount of 0.007 mg, which was almost no Ag. Accordingly, the reaction time of less than 3 minutes was confirmed to be insufficient to form silver in the electroless plating method (refer to FIG. 4 and Table 1).

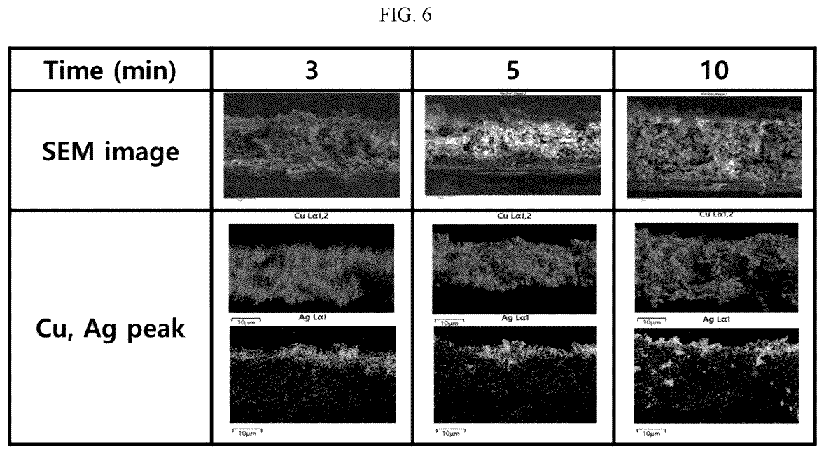

The cross-sectional scanning electron microscopy (SEM) and Energy-Dispersive X-ray Spectroscopy (EDS) analysis results of the structure confirmed that the structure maintained its shape due to the Ag reaction. In addition, when the float coating method was applied, Ag was confirmed to be formed only on the surface of the structure (refer to FIG. 6).

TABLE 1

Composition (mg)

| Time (min) | Ag | Cu |
|---|---|---|
| 1 | 0.007000 | 8.930 |
| 2 | 0.06057 | 8.696 |
| 5 | 0.1271 | 8.834 |
| 10 | 0.1823 | 8.606 |

### Evaluation 2: Controlling the Ratio of Graphite Nanofibers (GNFs)

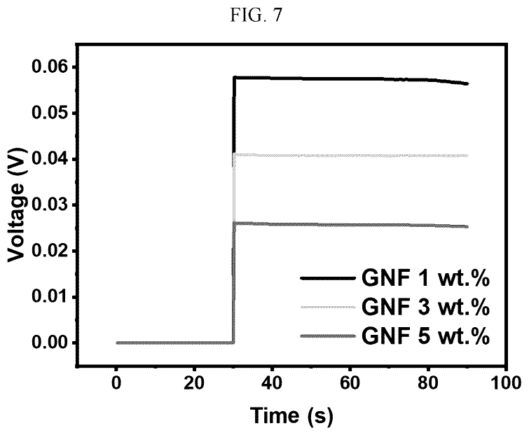

A two-terminal direct current (DC) resistance measurement method was used to measure electrical conductivity, which confirmed that the higher GNF ratio, the higher connectivity of Cu particles and thus the higher overall electrical conductivity of a structure (Refer to FIG. 7 and Table 2).

The test was performed by setting the GNF ratio to 1 wt %, 3 wt %, and 5 wt %, which confirmed the higher ratio, the higher electrical conductivity and the lower resistance (Refer to FIG. 7 and Table 2). The results shown in Table 2 was calculated according to Equation 1:

ρ=(R·S)/L=(U·S)/(I·L)
U: average voltage increase
S: area of the electrode (r=5 mm)
I: applied current (5 mA)
L: thickness of the electrode.

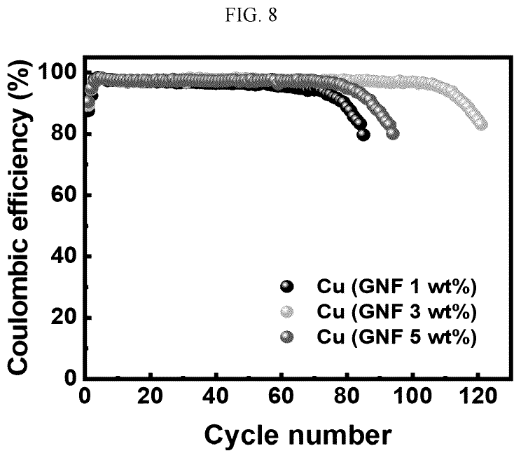

When the conductivity was low, the structure lost electrical connections with the other structures and failed in properly functioning, but when the conductivity was high, a phenomenon that lithium was electrodeposited on the structure occurred, which confirmed that required was conductivity at an appropriate level and that a structure manufactured at a ratio of 3 wt % exhibited the highest performance (refer to FIG. 8).

TABLE 2

| | GNF 1 wt % | GNF 3 wt % | GNF 5 wt % |
|---|---|---|---|
| L(μm) | 28 | 28 | 28 |
| U(V) | 0.0578 | 0.411 | 0.0265 |
| ρ(Ω · m) | 31.98 | 23.04 | 13.61 |
| σ(S/m) | 0.031 | 0.043 | 0.072 |

### Evaluation 3: Lithium Electrodeposition on a Conductive Porous Structure

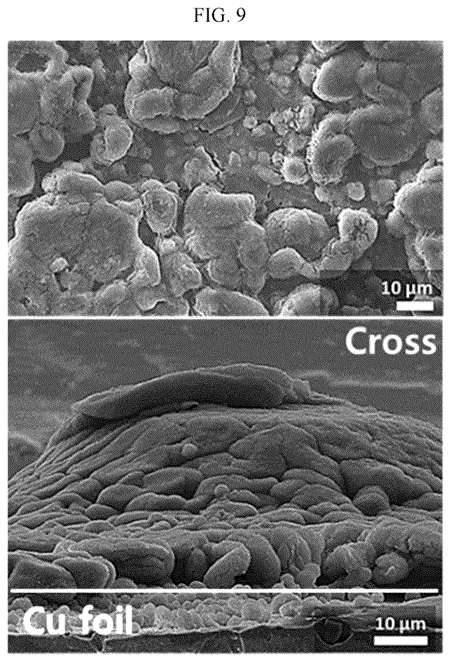

Comparative Example 1, in which a copper foil was applied, exhibited non-uniform electrodeposition in a curved shape (refer to FIG. 9).

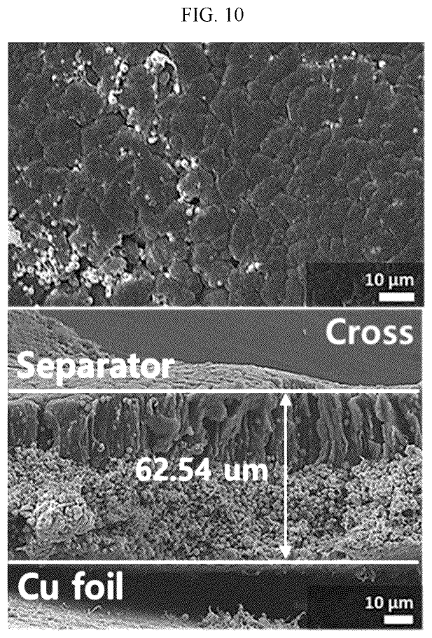

Comparative Example 2 confirmed that lithium was electrodeposited on the top of the structure. This showed that when the lithium-affinity material was not applied, lithium was electrodeposited on the top rather than inside the structure. The lithium electrodeposited on the top of the structure made a thickness of the structure and the electrodeposited lithium thick to 62.54 μm (refer to FIG. 10).

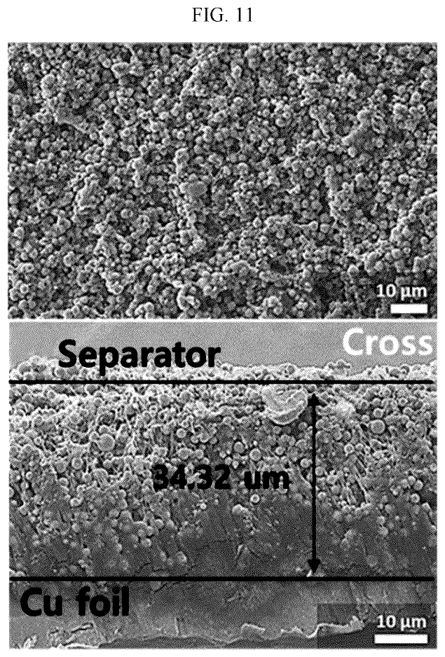

Example 1 was confirmed to exhibit that lithium was electrodeposited inside the structure. This was achieved by applying a lithium-affinity metal so that lithium was electrodeposited through filling the structure from the bottom of the structure. The lithium was electrodeposited inside the structure, thereby reducing a thickness of the electrodeposited lithium in the structure to 34.32 μm, which was thin (refer to FIG. 11).

### Evaluation 4: Nucleation Overvoltage Difference

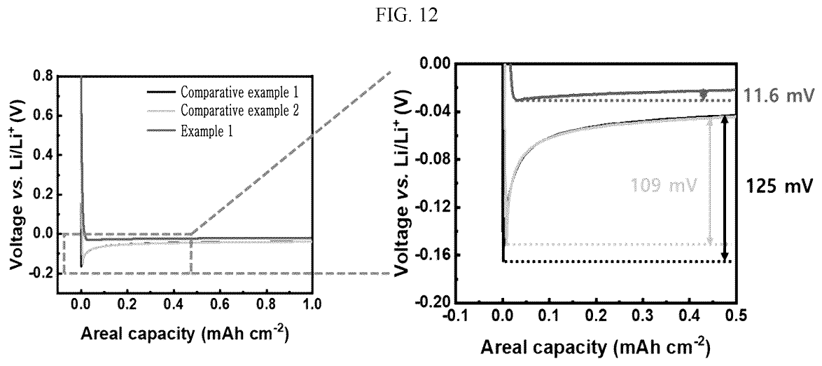

Comparative Examples 1 and 2, which used copper as a main component, had no lithium affinity properties. Accordingly, a high nucleation overvoltage of greater than or equal to 100 mV appeared (refer to FIG. 12).

Example 1 exhibited a low nucleation overvoltage due to presence of silver, a lithium affinity metal. This indicates that lithium reacted with the silver at the start of the lithium electrodeposition (refer to FIG. 12).

### Evaluation 5: Battery Cell Test

(1) Evaluation of Lithium Ion Reversibility Through Half-Cell Cycle-Life Evaluation Using a Conductive Porous Structure Manufactured without Using Lithium Affinity Silver.

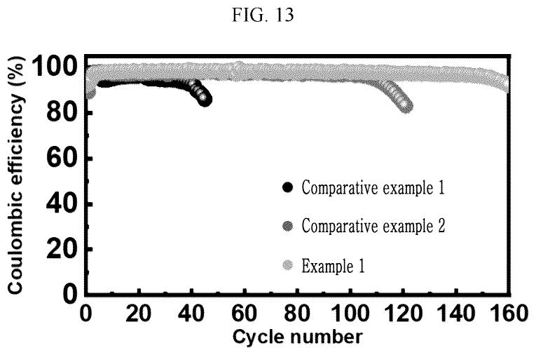

Example 1, to which silver was applied, exhibited the highest performance, and followed by Comparative Example 2, in which silver was not applied to the structure, and Comparative Example 1 (copper foil), to which the structure was not applied, exhibited the lowest performance (refer to FIG. 13).

(2) Battery Cell Electrochemical Tests of Conductive Porous Structures Manufactured without Using Lithium Affinity Silver.

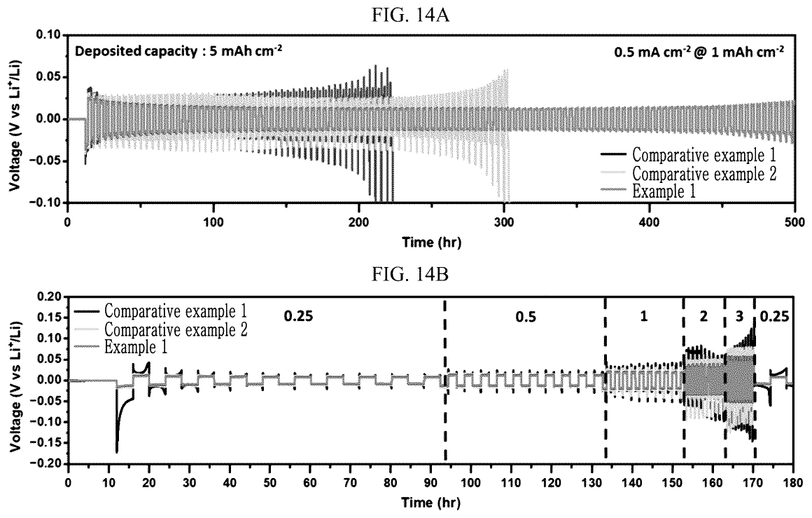

A symmetrical cell cycle-life test (refer to FIG. 14A) and an output test (refer to FIG. 14B) also exhibited performance in the same order as in the (1), wherein Example 1 exhibited the highest performance.

(3) Full-Cell Test of Conductive Porous Structures Manufactured without Using Lithium Affinity Silver.

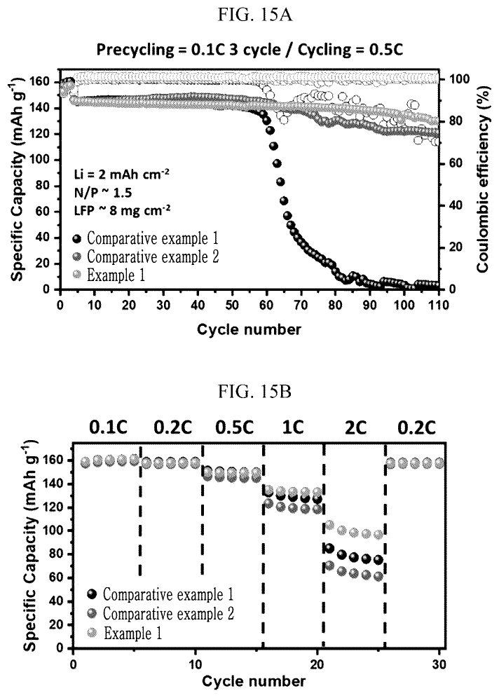

A full cell cycle-life test (refer to FIG. 15A) and a cycle-life test (refer to FIG. 15B) exhibited performance in the same order as in the (1), wherein Example 1 exhibited the highest performance.

While this disclosure has been described in connection with what is presently considered to be practical example embodiments, it is to be understood that the present disclosure is not limited to the disclosed embodiments, but, on the contrary, is intended to cover various modifications and equivalent arrangements included within the spirit and scope of the appended claims. Therefore, the aforementioned embodiments should be understood to be examples but not limiting the present disclosure in any way.

What is claimed is:

1. A support for a lithium metal negative electrode having a lithium affinity gradient, the support comprising:
a separator;
a layer including conductive metal nanoparticles and being on the separator; and
a lithium affinity layer on the layer including the conductive metal nanoparticles,
wherein the layer including the conductive metal nanoparticles further includes pores.

2. The support of claim 1, wherein
the support for the lithium metal negative electrode has a porosity in a range of 60% to 97%.

3. The support of claim 1, wherein
the lithium affinity layer comprises a lithium ion affinity element.

4. The support of claim 3, wherein
the lithium ion affinity element comprises silver (Ag), zinc (Zn), gold (Au), aluminum (AI), carbon (C), or a combination thereof.

5. The support of claim 1, wherein
the layer including the conductive metal nanoparticles comprises a conductive metal element and a conductive carbon fiber.

6. The support of claim 5, wherein
the conductive metal element comprises copper (Cu), iron (Fe), nickel (Ni), or a combination thereof.

7. The support of claim 5, wherein
the conductive carbon fiber comprises a carbon nanotube (CNT), a graphite nanofiber (GNF), or a combination thereof.

8. The support of claim 5, wherein
the support for the lithium metal negative electrode further comprises a binder.

9. The support of claim 8, wherein
the conductive carbon fiber is included in an amount in a range of 1 wt % to 5 wt % based on a total weight (100 wt %) of the conductive metal element, the conductive carbon fiber, and the binder.

10. The support of claim 1, wherein
the support for the lithium metal negative electrode has a thickness in a range of 10 μm to 100 μm.

11. A method of manufacturing a support for a lithium metal negative electrode, comprising:
adding a mixture of a conductive metal element, a conductive carbon fiber, and a binder to a solvent;
adding a pore-forming agent to the solvent to which the mixture is added to prepare a slurry;
casting the slurry onto a separator;
drying the slurry casted onto the separator;
etching, after drying the slurry casted onto the separator, to obtain a support for a lithium metal negative electrode in a first state; and
reacting the support in the first state with a solution including a lithium ion affinity element.

12. The method of claim 11, wherein the support in the first state does not have a lithium affinity gradient.

13. The method of claim 11, wherein
reacting the support in the first state with the solution including the lithium ion affinity element includes float-coating, in the solution including the lithium ion affinity element, the support in the first state.

14. The method of claim 11, wherein
the pore-forming agent comprises sodium chloride (NaCl), sucrose, silica, polymethyl methacrylate (PMMA), styrene, iron oxide (Fe₂O₃), nickel (II) oxide (NiO), alumina (Al₂O₃), or a combination thereof.

15. The method of claim 11, wherein
reacting the support in the first state with the solution including the lithium ion affinity element is performed for a time period of more than 1 minute and less than 10 minutes.

16. The method of claim 11, wherein
the conductive carbon fiber is included in an amount in a range of 1 wt % to 5 wt % based on a total weight (100 wt %) of the mixture of the conductive metal element, the conductive carbon fiber, and the binder.

17. The method of claim 11, further comprising:
obtaining the support in a second state by reacting the support in the first state with the solution including the lithium ion affinity element, wherein the support in the second state includes a lithium affinity gradient.

18. The method of claim 11, wherein
the lithium ion affinity element comprises silver (Ag), zinc (Zn), gold (Au), aluminum (AI), carbon (C), or a combination thereof.

19. The method of claim 11, wherein
the conductive metal element comprises copper (Cu), iron (Fe), nickel (Ni), or a combination thereof.

20. The method of claim 11, wherein
the conductive carbon fiber comprises a carbon nanotube (CNT), a graphite nanofiber (GNF), or a combination thereof.
